(19) United States
(12) Patent Application Publication
(10) Pub. No.: US 2023/0406667 A1
(43) Pub. Date: Dec. 21, 2023

(54) MACHINE AND PROCESS FOR FOLDING, CUTTING, AND STACKING NAPKINS

(71) Applicant: OMET S.R.L., Lecco (IT)

(72) Inventors: Marco CALCAGNI, Lecco (IT); Roberto PEREGO, Moggio (Lecco) (IT)

(21) Appl. No.: 18/247,188

(22) PCT Filed: Sep. 29, 2021
(86) PCT No.: PCT/IB2021/058930

§ 371 Date: Mar. 29, 2023

(30) Foreign Application Priority Data
Sep. 29, 2020 (IT) 102020000022963

(51) Int. Cl. B65H 45/101; B65H 45/24; B31D 1/04

(52) U.S. Cl. CPC B65H 45/101; B65H 45/24; B31D 1/04; B65H 2701/1924; B65H 2301/5151

(57) ABSTRACT

A machine for folding, cutting, and stacking napkins is provided. The machine has a feeding station, at least one pair of folding rollers pivoting about horizontal rotational axes, a blade, and a pair of spacers having fingers configured to support the napkins stably downstream of the blade, with respect to a horizontal plane perpendicular to a direction of travel, the folding rollers being provided with circumferential slots for inserting the spacers.

### TECHNICAL FIELD

This invention is generally in the field of sheet product processing; in particular, the invention relates to a machine and process for folding, cutting, and stacking napkins.

### PRIOR ART

Equipment for manufacturing napkins is known, comprising a station for conveying a continuous sheet of material to a pair of folding cylinders, arranged along a vertical rotation axis.

As the sheet passes through the cylinders, it is folded in a zig-zag motion (in a known manner, for example by providing each roller with a radially projecting profile and a radially recessed groove, angularly offset from each other, whereby at each turn the pin of one roller fits into the groove of the other roller, pinching the sheet and folding it), arranging itself downstream of the cylinders in a stack which, advancing according to a horizontal feed direction, is pressed against a blade, which cuts the stack into two identical portions, containing a plurality of napkins.

A series of dividers is also provided, in the form of small brackets, which are inserted between the layers of the stack at intervals corresponding to the number of napkins intended to form a unit to be packaged. Said separators are driven passively by the stack as it moves along the feed direction or by a special motorized belt, and slide on guides associated with horizontal side members of a support frame of the machine.

However, a machine configured in this manner has a significant longitudinal footprint, and further requires the cylinders to exert significant thrust on the advancing stack for the blade to penetrate it.

Also known is a solution in which folding cylinders are oriented along a horizontal axis, whereby the feed direction of the stack being formed is vertical when the machine is in the operating condition. An example of such a solution is known from FR 2932172 A1, which describes equipment suitable primarily for cutting sheets of newsprint. This equipment provides for the sheets to be stacked one on top of the other with a zig-zag motion imparted by the folding rollers, but without the first layers downstream of the rollers being compressed between them, whereby the separators may be inserted between one fold and the next. In order for said rollers to exert an appropriate pressure on the layers of sheets upstream of the cutting blade, the known equipment provides a complex mechanism whereby the separators are disengaged from their guiding means downstream of the blade (being simultaneously made integral with the machine frame), while the upstream separators remain integral with the guiding means.

### SUMMARY OF INVENTION

One object of this invention is to provide an alternative machine and process for folding, cutting, and stacking napkins that are improved with respect to the prior art. To do this, spacer elements with fingers are provided, which, being movable so as to be placed under the folding cylinders, are adapted to support the stack in the downward feed motion toward and beyond the blade, downstream of which the spacers may unload the secondary stacks of cut napkins (for example, by placing them on a further platform, which is able to convey the products downstream with respect to the machine).

The spacers are inserted into the stack through circumferential slots on the side surfaces of the folding cylinders, in a number and arrangement corresponding to the number and arrangement of the fingers of the spacers, whereby said spacers may be inserted in the radial thickness of the folding cylinders (thus upstream of the radially outer perimeter of the folding cylinders).

In this way, by means of the spacers, it is possible to compress the stack of napkins immediately downstream of the release from the folding rollers, avoiding the complex disengagement mechanism provided by the solution according to the prior art.

The aforesaid and other objects and advantages are achieved, according to an aspect of the invention, by a machine and a process for folding, cutting, and stacking napkins having the features defined in the appended claims. Preferred embodiments of the invention are defined in the dependent claims.

### BRIEF DESCRIPTION OF THE DRAWINGS

The functional and structural features of some preferred embodiments of a machine and a process according to the invention will now be described. Reference is made to the appended drawings, wherein:

FIG. 1 through 4 are schematic perspective views of a plurality of components of a machine according to one embodiment of the invention, wherein a pair of folding cylinders, a pair of spacers, a blade, a storage platform for napkins cut downstream of the spacers, and a pair of slides suitable for receiving napkins from the aforesaid platform are shown in order; and

FIG. 5A through 16B are schematic front and top views, respectively, of a machine portrayed in a sequence of operations of the method for folding, cutting, and stacking napkins, according to an embodiment of this invention.

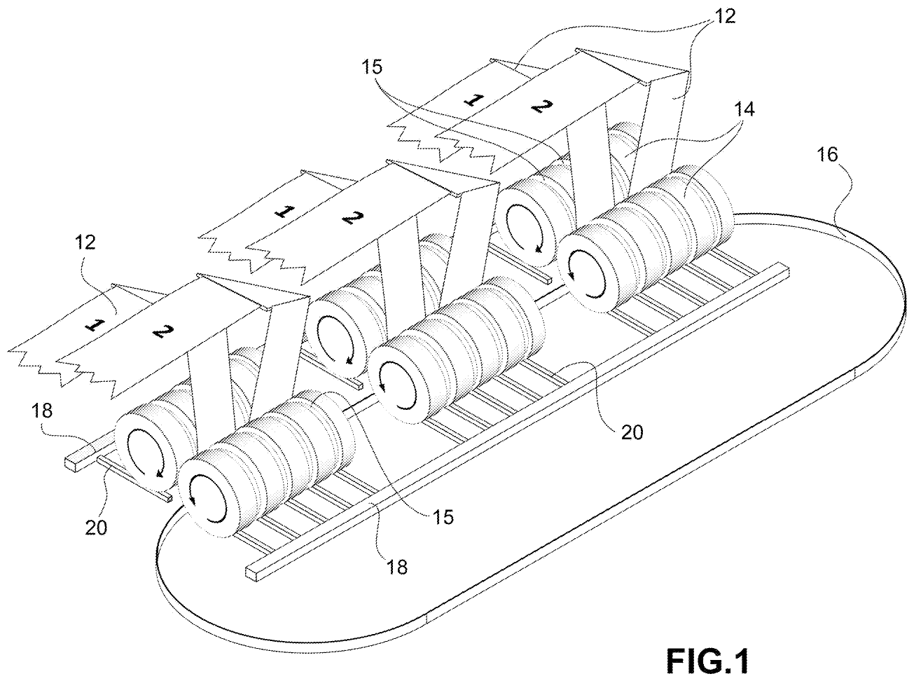

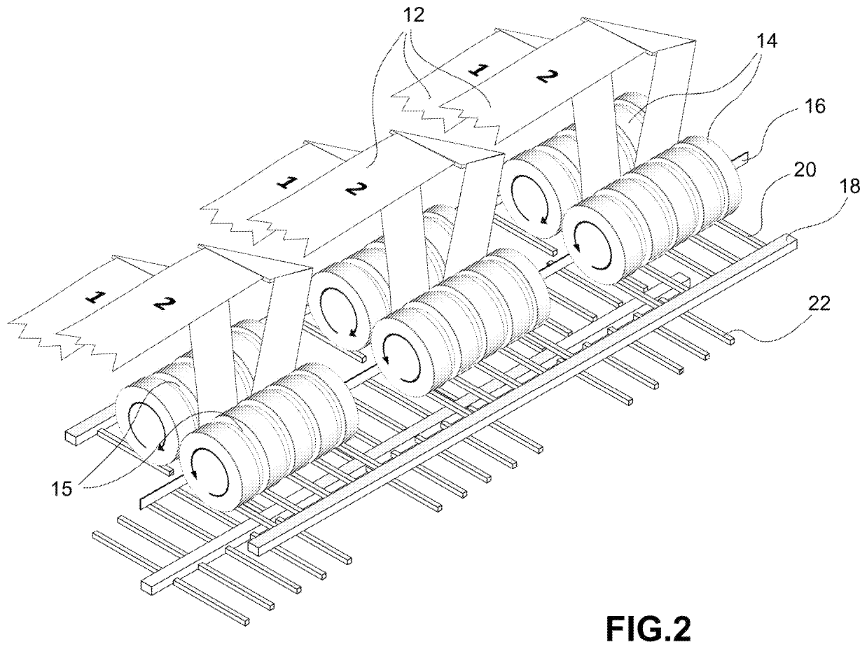

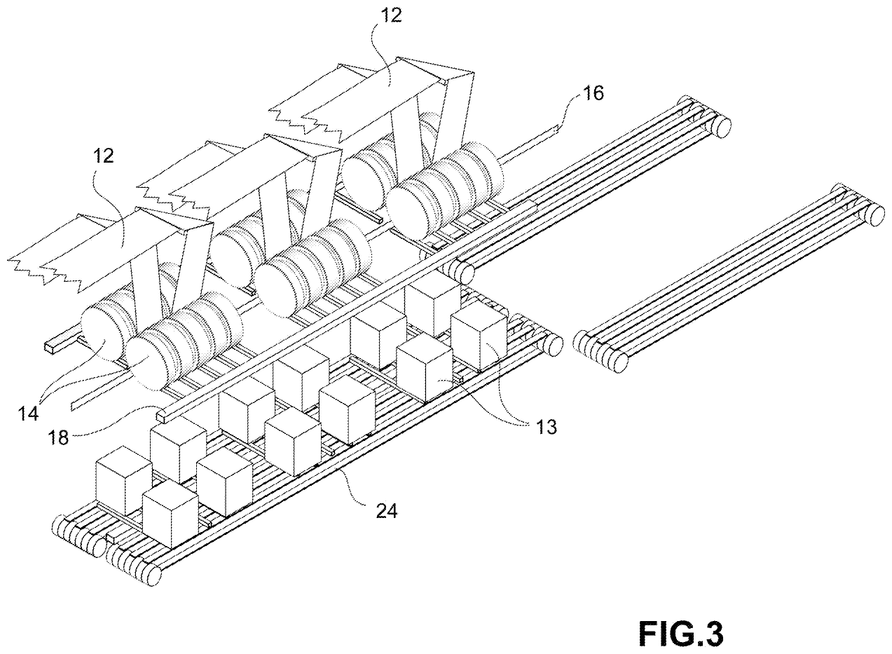

### DETAILED DESCRIPTION

Before describing a plurality of embodiments of the invention in detail, it should be clarified that the invention is not limited in its application to the construction details and configuration of the components presented in the following description or illustrated in the drawings. The invention may assume other embodiments and be implemented or constructed in practice in different ways. It should also be understood that the phraseology and terminology have a descriptive purpose and should not be construed as limiting.

Referring by way of example to the figures, a machine 9 for folding, cutting, and stacking napkins comprises a feeding station 10, which includes means configured to convey at least one continuous sheet 12 of a material from which a plurality of napkins 13 are to be made downstream of said feeding station 10, and at least one pair of folding rollers or cylinders 14, arranged downstream of the feeding station 10 and adapted to be fed said continuous sheet 12.

The folding rollers 14 are rotatable about mutually parallel axes of rotation and arranged, when in use, along a horizontal direction, said folding rollers 14 being configured to push the continuous sheet 12 so as to arrange it according to a plurality of overlapping zig-zag layers having a dimension, in a horizontal direction perpendicular to the axes of the folding rollers 14, equal to at least the width of two juxtaposed napkins 13. Said overlapping direction of said continuous sheet layers 12 defines a feed direction of the folding and stacking cycle of the machine 9 (a feed direction which, in an operating condition of the machine, is a substantially vertical direction).

The machine 9 further comprises a blade 16, arranged downstream of the folding rollers 14 parallel to the axes of said folding rollers, in a median position with respect to the interaxis of said folding rollers 14, said blade 16 being adapted to cut centrally said overlapping layers of the continuous sheet 12 fed by the folding rollers 14 so that two identical napkins 13 are formed from each layer.

Also a pair of spacers 18 is provided, movable in a direction parallel to said feed direction and in a direction parallel to the interaxis of the folding rollers 14, said spacers 18 being arranged symmetrically with respect to the blade 16 and having fingers 20 extended in a direction parallel to the interaxis of the folding rollers 14, said fingers 20 being configured to stably support the napkins 13 downstream of the blade 16, with respect to a horizontal plane perpendicular to the feed direction, and/or to compress the napkins 13 upstream of the blade 16 in the direction of said blade.

According to a preferred embodiment, the fingers 20 are mutually spaced along a horizontal direction, parallel to the interaxis of the folding rollers 14.

According to one embodiment, the machine 9 comprises a platform 22 having a support surface, lying on a horizontal plane perpendicular to the feed direction and adapted to receive the napkins 13 from the fingers 20 of the spacers 18, said platform 22 being movable along the feed direction.

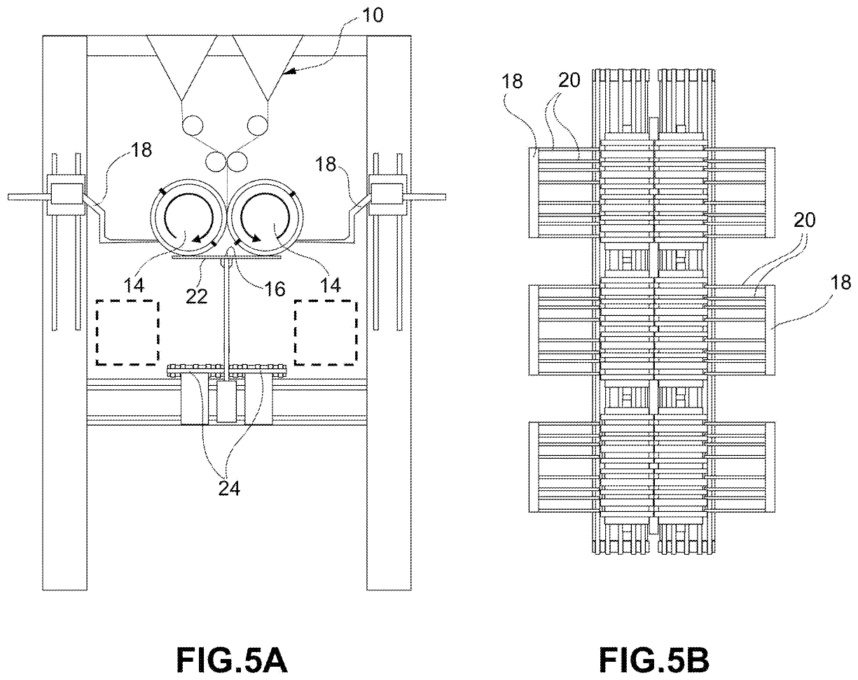

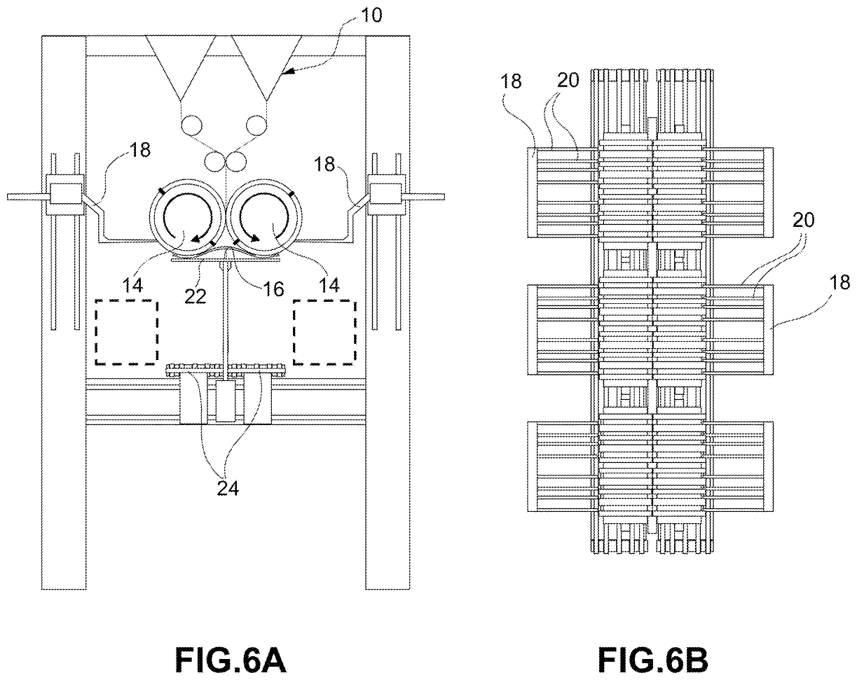

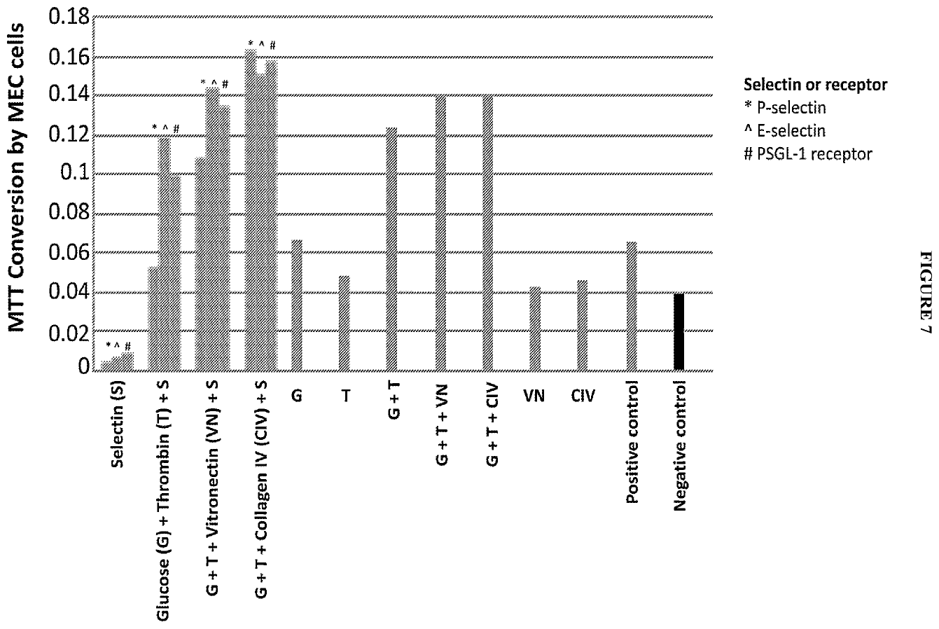

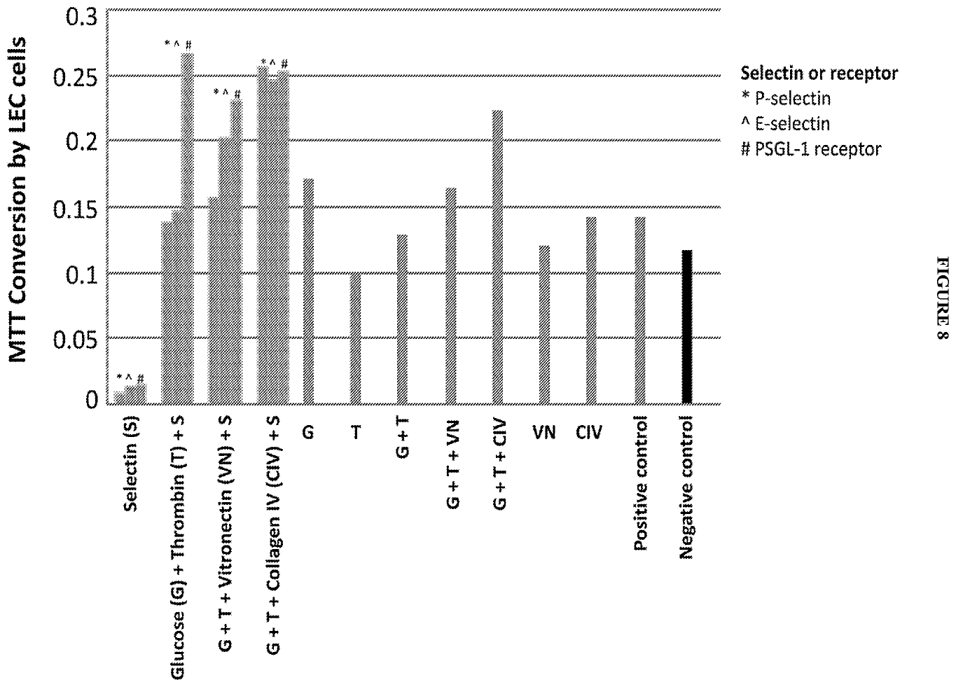

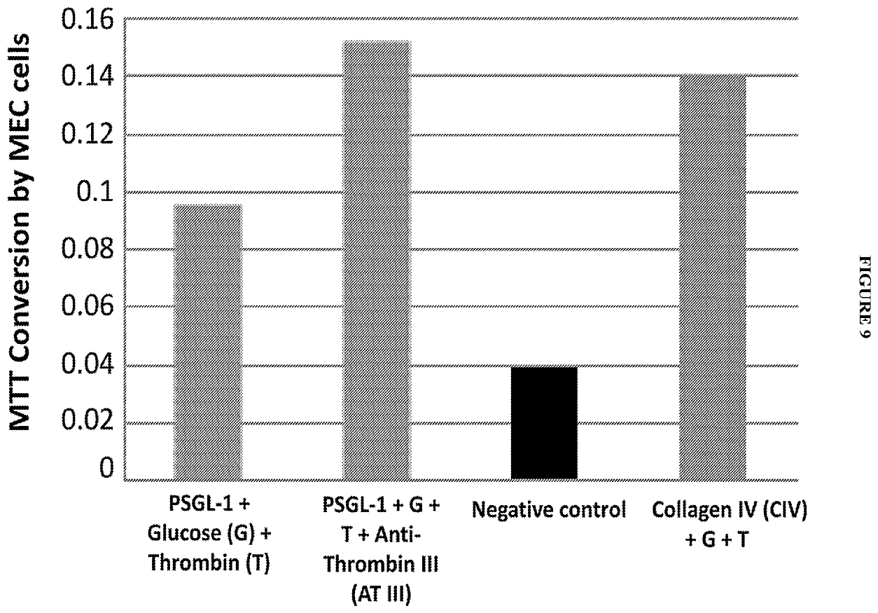

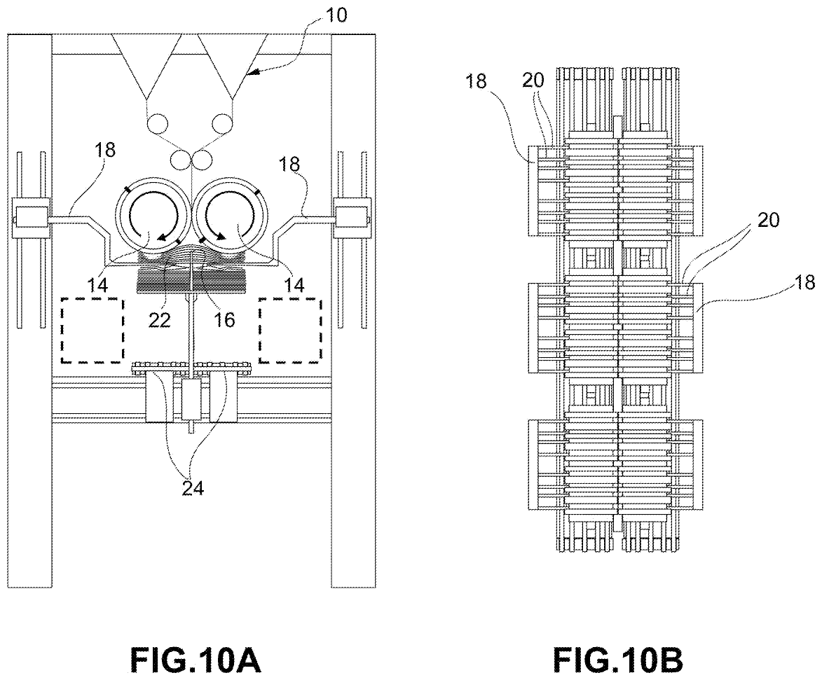

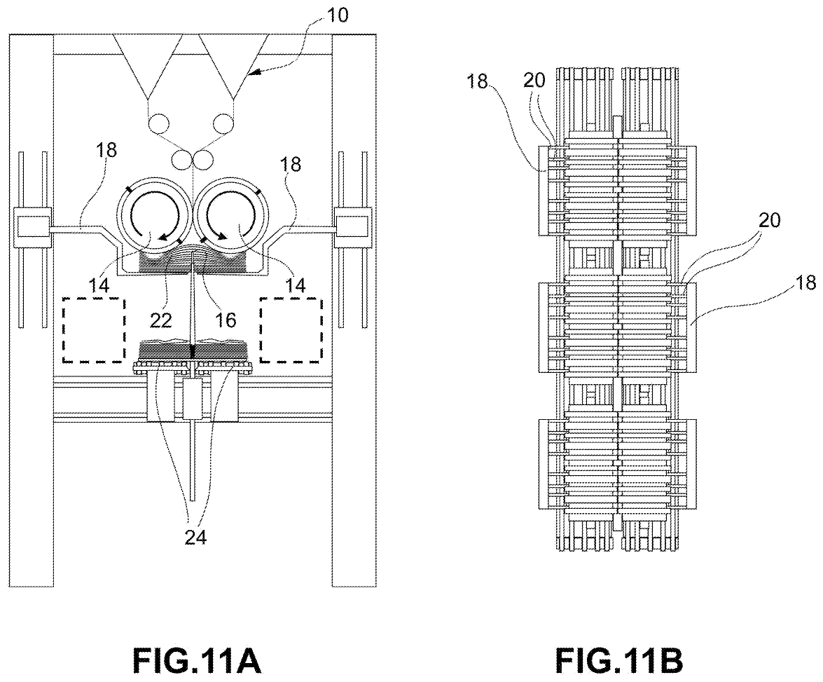

Said platform 22 may be configured to support the stack of continuous sheet layers 12 (being formed downstream of the folding cylinders 14) to carry them downstream of the blade 16; when said stack has reached a predetermined thickness (in the feed direction), the pair of spacers 18 is configured to be inserted into the stack being formed in the vicinity of the folding cylinders 14 to support an overlying portion of the stack being formed, while the platform 22 carries the first portion of the stack downstream (as shown by way of example in FIG. 5A through 11B).

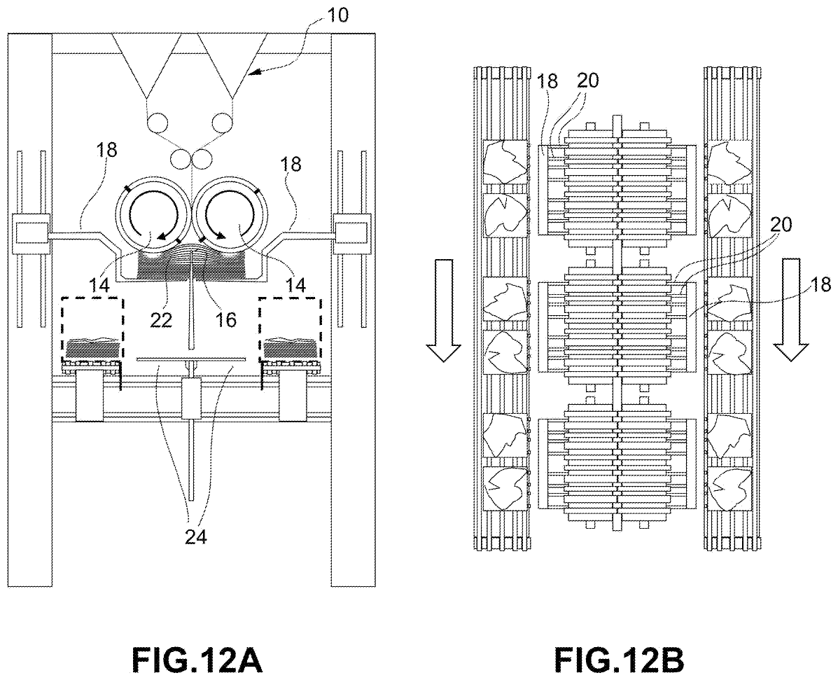

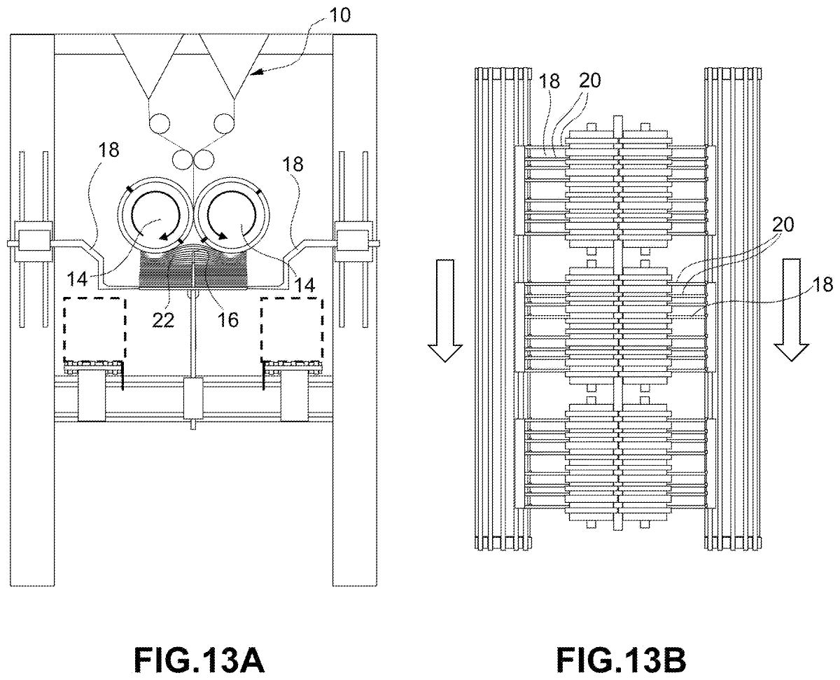

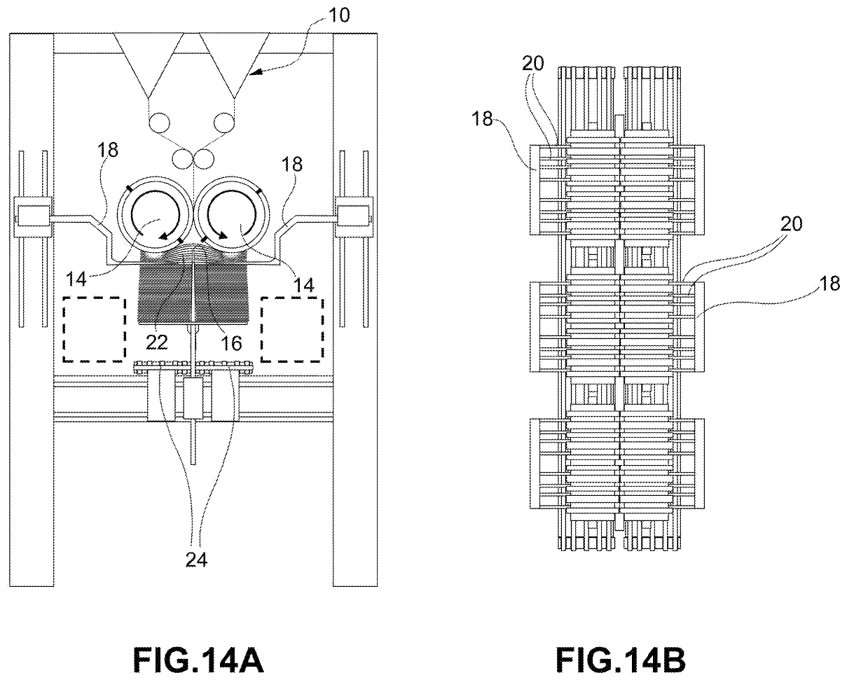

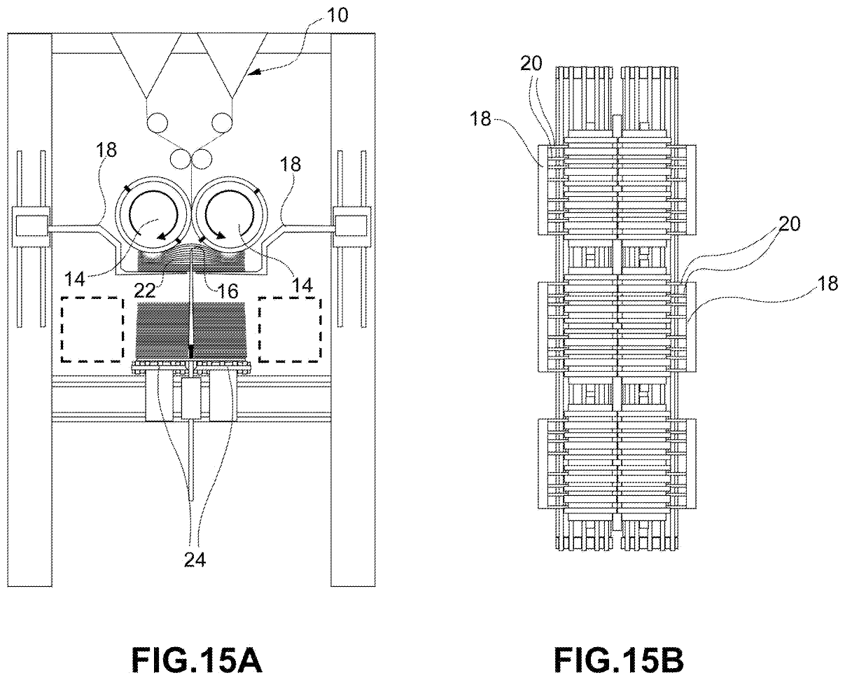

When the stack supported by the spacers 18 has also reached a predetermined thickness (in the feed direction), said spacers 18 are configured to arrange said stack on the platform 22, then to rise up and insert themselves into the stack being formed in the vicinity of the folding cylinders 14 to support an overlying portion of the stack being formed, while the platform 22 transports the first portion of the stack downstream (such as, for example, illustrated in FIG. 12A through 16B).

Said platform 22 may be configured to allow the interpenetration of the spacers 18 in the feed direction between said platform 22 and the fingers 20 (e.g., by presenting in turn mutually spaced fingers that are offset with respect to the fingers 20 of the spacers 18, whereby said spacers are insertable into the spaces between the fingers of the platform 22, so as to be able to penetrate the support surface thereof).

In this way (such as, for example, illustrated in FIG. 12A through 16B), when the stack of continuous sheet layers 12 has reached a predetermined thickness (corresponding, for example, to the thickness of a napkin packaging unit) downstream of the folding cylinders 14, the pair of spacers 18 supports the descent of said stack, until it is deposited on the platform 22 (penetrating its support surface, the fingers of which hold the napkins), which in turn takes charge of the stack and conveys it downstream of the machine.

Alternatively, or in combination with the platform 22, a second pair of spacers 18 may be provided whereby a first pair supports the descent of the stack being formed downstream of the folding cylinders 14 and, when said stack has reached a predetermined thickness (in the feed direction), the second pair of spacers 18 is inserted into the stack being formed in the vicinity of the folding cylinders 14 to support an overlying portion of the stack being formed, while the first pair of spacers 18 transports the first portion of the stack downstream.

The folding cylinders 14 have, on the side surfaces thereof, circumferential slots 15 in a number and arrangement corresponding to the number and arrangement of the teeth 20 of the spacers 18, said circumferential slots 15 being adapted to allow the insertion of said teeth 20 into the radial thickness of the folding cylinders 14. In this way, the insertion of the pair of spacers 18 into the stack being formed is facilitated by isolating a portion of said spacers (which is taken over by the platform 22 or an additional pair of spacers 18) downstream from a portion in formation abutting the folding cylinders 14.

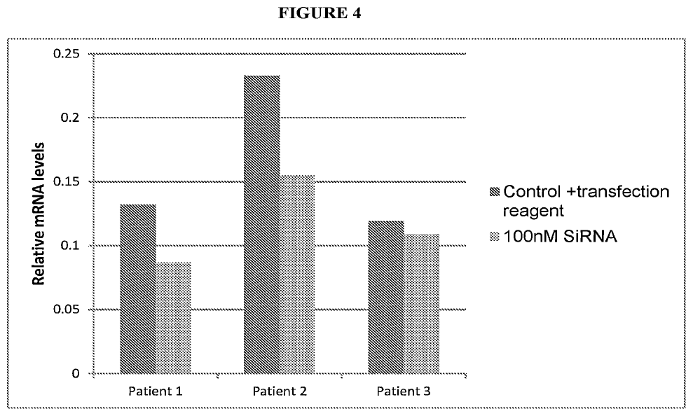

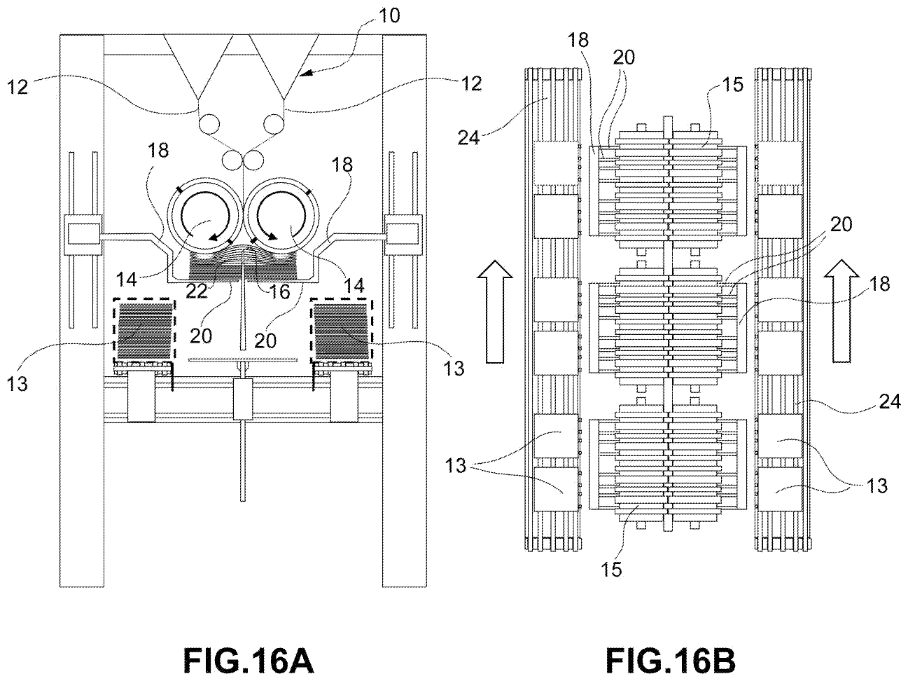

A pair of horizontal slides 24 may be further provided, arranged symmetrically with respect to the blade 16 and movable along a direction parallel to the interaxis of the folding rollers 14, said slides 24 being adapted to receive the napkins 13 from the fingers 20 of the spacers 18 or from the platform 22. Expediently, said slides 24 may be equipped with conveyor belts, adapted to move the napkins 13 along a direction parallel to the axes of the folding rollers 14, so as to remove them from the machine (as shown, for example, in FIGS. 4 and 16B).

Expediently, the continuous sheet material 12 from which a plurality of napkins 13 may be made, may be a cellulose-based material (when, for example, the machine is configured to make traditional paper napkins).

According to a further aspect of the invention, a process for folding, cutting, and stacking napkins comprises the steps of providing a machine 9 according to any of the embodiments described above; feeding a continuous sheet 12 of a material with which a plurality of napkins 13 are to be made to the folding rollers 14; moving the spacers 18 in a direction parallel to the interaxis of the folding rollers 14 (and, therefore, perpendicular to the feed direction of the napkins), whereby the respective fingers 20 fit into corresponding circumferential slots 15 of the folding rollers 14, arranged below said rollers (i.e., downstream thereof); by means of the folding rollers 14, moving the continuous sheet 12 in a zig-zag pattern perpendicular to the feed direction, so as to form a stack of overlapping layers along the feed direction, said layers having a dimension, in a horizontal direction perpendicular to the axes of the folding rollers 14, equal to at least the width of two juxtaposed napkins 13, said layers being collected by the fingers 20; moving the spacers 18 in a direction parallel to the feed direction, until at least part of the overlapping layers of the continuous sheet 12 has passed through the blade 16; and removing the napkins 13 from the spacers 18.

Further, in this description and in the claims, the terms and expressions indicating positions and orientations, such as “longitudinal,” “transverse,” “vertical,” or “horizontal” are to refer to the direction of stacking of the layers of sheet material, downstream of the folding cylinders.

Various aspects and embodiments of a machine and a process according to the invention have been described. It is understood that each embodiment may be combined with any other embodiment. Furthermore, the invention is not limited to the described embodiments, but may be varied within the scope defined by the appended claims.

1. A machine for folding, cutting and stacking napkins, comprising:
a feeding station comprising means for conveying downstream of said feeding station at least one continuous sheet of a material with which a plurality of napkins is to be made;
at least one pair of folding rollers, arranged downstream of the feeding station and adapted to be fed with said at least one continuous sheet-, said folding rollers being rotatable about axes of rotation mutually parallel and arranged, in use, along a horizontal direction, said folding rollers being configured to push the at least one continuous sheet so that the at least one continuous sheet is arranged in a plurality of overlapping zig-zag layers having a dimension, in a horizontal direction perpendicular to the axes of rotation of the folding rollers, equal to at least a width of two juxtaposed napkins, ar overlapping direction of said overlapping zig-zag layers of the at least one continuous sheet defining a feed direction of a folding and stacking cycle of the machine;
a blade, arranged downstream of the folding rollers parallel to the axes of rotation of the folding rollers, in a median position with respect to an interaxis of said folding rollers, said blade being adapted to cut centrally said super-posed overlapping zig-zag layers of the at least one continuous sheet so that two identical napkins are formed from each layer of the plurality of overlapping zig-zag layers; and
a pair of spacers, movable along a direction parallel to said feed direction and along a direction parallel to the interaxis of the folding rollers, said spacers being arranged symmetrically with respect to the blade and having fingers elongated in a direction parallel to the interaxis of the folding rollers, said fingers being configured to stably support the napkins downstream of the blade, with respect to a horizontal plane perpendicular to the feed direction, and/or compressing the napkins upstream of the blade toward said blade;
wherein the folding rollers have, on their side surfaces, circumferential slots in a number and an arrangement corresponding to a number and an arrangement of the fingers of the spacers, said circumferential slots being adapted to allow insertion of said fingers into a radial thickness of the folding rollers.

2. The machine of claim 1, wherein the fingers are mutually spaced along a horizontal direction, parallel to the interaxis of the folding rollers.

3. The machine of claim 1, comprising a platform having a support surface, lying on the horizontal plane perpendicular to the feed direction and adapted to receive the napkins from the finger of the spacers, said platform being movable along the feed direction.

4. The machine of claim 3, wherein the platform is configured to allow interpenetration in the feed direction between said platform and the fingers of the spacers.

5. The machine of claim 1, further comprising a pair of horizontal slides, arranged symmetrically with respect to the blade and movable along a direction parallel to the interaxis of the folding rollers, said pair of horizontal slides being adapted to receive the napkins from the fingers of the spacers or from the platform.

6. The machine of claim 1, wherein the material of the at least one continuous sheet, with which the plurality of napkins is to be made, is a cellulose-based material.

7. A method for folding, cutting, and stacking napkins, comprising:
a) providing a machine for folding, cutting and stacking napkins, comprising:
a feeding station comprising means for conveying downstream of said feeding station at least one continuous sheet of a material with which a plurality of napkins is to be made;
at least one pair of folding rollers, arranged downstream of the feeding station and adapted to be fed with said at least one continuous sheet, said folding rollers being rotatable about axes of rotation mutually parallel and arranged, in use, along a horizontal direction, said folding rollers being configured to push the at least one continuous sheet so that the at least one continuous sheet is arranged in a plurality of overlapping zig-zag layers having a dimension, in a horizontal direction perpendicular to the axes of rotation of the folding rollers, equal to at least a width of two juxtaposed napkins, an overlapping direction of said overlapping zig-zag layers of the at least one continuous sheet defining a feed direction of a folding and stacking cycle of the machine;
a blade, arranged downstream of the folding rollers parallel to the axes of rotation of the folding rollers, in a median position with respect to an interaxis of said folding rollers, said blade being adapted to cut centrally said overlapping zig-zag layers of the at least one continuous sheet so that two identical napkins are formed from each layer of the plurality of overlapping zig-zag layers; and
a pair of spacers, movable along a direction parallel to said feed direction and along a direction parallel to the interaxis of the folding rollers, said spacers being arranged symmetrically with respect to the blade and having fingers elongated in a direction parallel to the interaxis of the folding rollers, said fingers being configured to stably support the napkins downstream of the blade, with respect to a horizontal plane perpendicular to the feed direction, and/or compressing the napkins upstream of the blade toward said blade;
wherein the folding rollers have, on their side surfaces, circumferential slots in a number and an arrangement corresponding to a number and an arrangement of the fingers of the spacers, said circumferential slots being adapted to allow insertion of said fingers into a radial thickness of the folding rollers;
b) feeding the folding rollers with the at least one continuous sheet;
c) moving the spacers in the direction parallel to the interaxis of the folding rollers, so that respective fingers are arranged under corresponding folding rollers;
d) moving, by the folding rollers, the at least one continuous sheet in a zig-zag direction perpendicular to the feed direction to form a stack of overlapping zig-zag layers along the feed direction, said overlapping zig-zag layers being collected by the fingers;
e) moving the spacers in a direction parallel to the feed direction, until at least some of the overlapping zig-zag layers of the at least one continuous sheet have passed through the blade; and
f) removing the napkins from the spacers.

8. The method of claim 7, wherein step c) is preceded by a step of collecting the stack of overlapping zig-zag layers of the at least one continuous sheet coming out of the folding rollers on the platform and moving said platform in a direction parallel to the feed direction, until at least some of the overlapping zig-zag layers of the at least one continuous sheet have passed through the blade.

9. The method of claim 8, wherein step f) is performed by transferring the napkins from the spacers to the platform.
